(19) United States
(12) Patent Application Publication
(10) Pub. No.: US 2003/0186645 A1
(43) Pub. Date: Oct. 2, 2003

(54) Method for marking a portion of a media broadcast for later use

(76) Inventor: Robert Mori, Palo Alto, CA (US)

Correspondence Address: ROSENTHAL & OSHA L.L.P. / SUN, 1221 MCKINNEY, SUITE 2800, HOUSTON, TX, 77010, US

(21) Appl. No.: 10/116,379

(22) Filed: Apr. 2, 2002

(51) Int. Cl. H04H 1/00

(52) U.S. Cl. 455/3.01; 455/3.06

(57) ABSTRACT

A method and apparatus for marking a portion of a media broadcast for later use is provided. Further, a method and apparatus that use a device located on an broadcast media receiver to record data representing a portion of a media broadcast is provided. Further, a method and apparatus that retrieve data representing a portion of a media broadcast is provided.

### BACKGROUND OF INVENTION

Broadcast media, i.e., audio and video broadcasts, is commonly used to provide information and entertainment to a user through a series of broadcast programs. Broadcast media is typically transmitted using a transmitter, and may be converted into an audible and/or viewable medium using various types of receivers. Examples of receivers include televisions, conventional radios, and Internet media players, i.e., media players used to receive streaming media broadcasts via the Internet. A streaming media broadcast may include streaming video, i.e., a sequence of “moving images” sent in compressed form over the Internet, and audio, which is transmitted as a continuous stream of data that may be played as it arrives.

In some cases, a user may want to record a broadcast media program for later use. Although several methods/devices to record broadcast programs currently exist, these methods/devices typically require programming and/or setup of a recording device prior to the broadcast of the broadcast program in order to obtain a record of the entire program. Often, when a user spontaneously hears/views a broadcast program, it is not always possible to program/setup a recording device prior to or even during the broadcast program.

One prior art device manufactured by Sony™, an eMarker, allows a user to “mark” an audio program spontaneously heard on a conventional radio. Using a Sony™ eMarker (a small electronic device designed to be hung on a keychain), a user can time stamp a song heard on a conventional radio during the time of listening. Afterwards, the eMarker may be plugged into a personal computer's USB data input port so that the user can log onto an eMarker service using the personal computer's web browser.

Each user of the eMarker service has a personal eMarker profile saved on a server running the eMarker service. A particular user's personal eMarker profile includes at least the frequency of the user's default broadcast station. Using a timestamp recorded by the eMarker, the server can retrieve the name of a song playing on the user's default broadcast station at the time represented by the timestamp. Each time the user wishes to retrieve the name of a song played on a station other than the user's default broadcast station, the user must change the frequency of the default broadcast station stored in the personal eMarker profile. In addition to retrieving the name of the song, the user may be able to listen to a clip from the song, purchase a CD including the song, or obtain information related to the song, e.g., the singer/band or the song played immediately before/after the song of interest.

### SUMMARY OF INVENTION

According to one aspect of the invention, a method for recording data representing a portion of a media broadcast comprises receiving a media broadcast using a broadcast media receiver having a selection device; playing the media broadcast using the broadcast media receiver; and recording a token during the portion of the media broadcast using the selection device, wherein the token comprises data representing the portion of the media broadcast.

According to another aspect, a broadcast media receiver for marking a portion of a media broadcast comprises a receiving device that plays the portion of the media broadcast; a selection device, wherein activating the selection device during the portion of the media broadcast creates a token; and a recording device for storing the token, wherein recording the token to the recording device marks the portion of the media broadcast.

According to another aspect, a method for retrieving data representing a portion of a media broadcast comprises playing the media broadcast using a broadcast media receiver having a selection device; recording a token during the portion of the media broadcast using the selection device, wherein the token represents the portion of the media broadcast; storing the token in a user profile; and retrieving data representing the portion of the media broadcast using the user profile.

According to another aspect, a device for retrieving data representing a portion of a media broadcast comprises broadcast media receiver means for playing the portion of the media broadcast; selection device means located on the broadcast media receiver means for creating a token representing the portion of the media broadcast; and recording device means activated by the selection device means for storing the token, wherein the recording device means uses the token to retrieve data representing the portion of the media broadcast.

Other aspects and advantages of the invention will be apparent from the following description and the appended claims.

### BRIEF DESCRIPTION OF DRAWINGS

FIG. 1a shows a device used to mark and view data representing a streaming media broadcast in accordance with an embodiment of the present invention.

FIG. 1b shows a process used to mark and view data representing a streaming media broadcast in accordance with an embodiment of the present invention.

FIG. 2a shows a device used to mark data representing a conventional media broadcast in accordance with an embodiment of the present invention.

FIG. 2b shows a device used to view data representing a conventional media broadcast in accordance with an embodiment of the present invention.

FIG. 2c shows a process used to mark and view data representing a conventional media broadcast in accordance with an embodiment of the present invention.

FIG. 3 shows a user profile menu in accordance with an embodiment of the present invention.

### DETAILED DESCRIPTION

Embodiments of the present invention will be described with reference to the accompanying drawings. Like items in the drawings are shown with the same reference numbers.

Embodiments of the present invention relate to a method and apparatus for marking a portion of a media broadcast for later use. Embodiments of the present invention further relate to a method and apparatus that use a device located on an broadcast media receiver to record data representing a portion of a media broadcast.

The present invention uses a selection device, referred to herein as a “memo button,” located on a broadcast media receiver to mark a media program transmitted by a broadcast media transmitter. For example, if a user presses the memo button while viewing/listening to a particular media program on a broadcast media receiver, the memo button records data representing the media program. Afterwards, the recorded data may be used by a computer to make the media program and/or any related information available to the user.

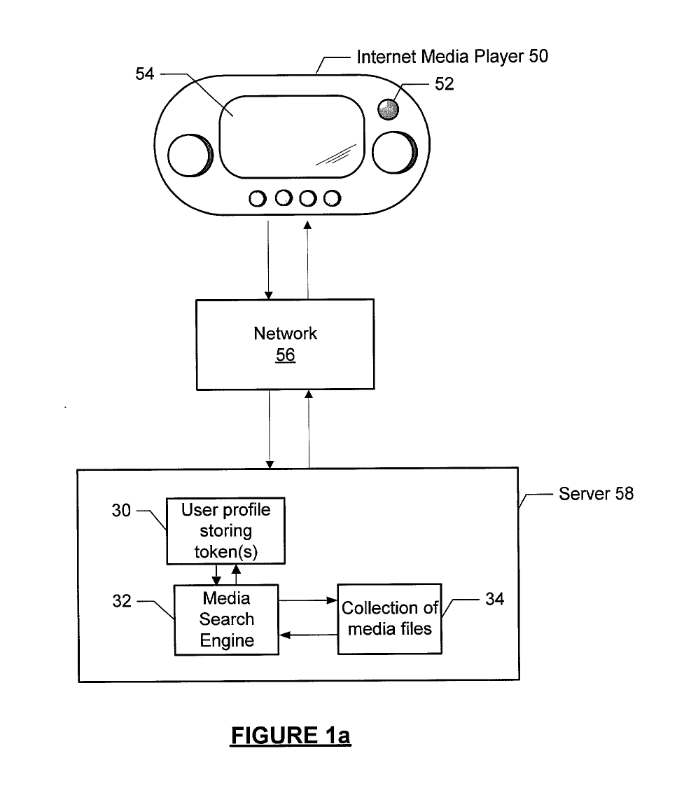

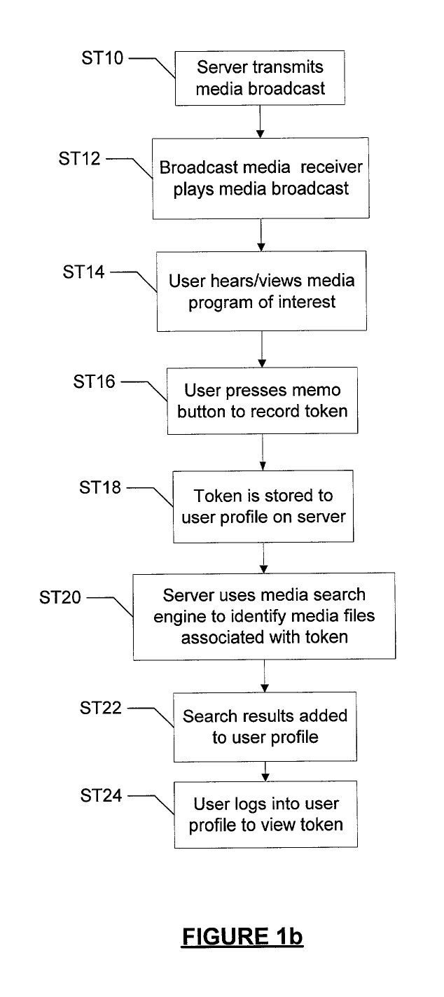

Broadcast media may be transmitted as a streaming media broadcast, via the Internet, and/or as a conventional media broadcast, via air waves. FIG. 1a shows a device used to mark and view data representing a streaming media broadcast. In FIG. 1a, an Internet media player (50) communicates with a server (58) via a network (56). In some embodiments, the network is a physical network that physically connects the Internet media player (50) and the server (58). For example, the Internet media player (50) may be a software device running on the desktop of a workstation connected to a server via a network cable. In another set of embodiments, the network is a wireless network. For example, the Internet media player (50) may be a hardware device, such as a car radio, that transmits data to and receives data from a server via radio waves.

Referring again to FIG. 1a, the Internet media player (50) receives a streaming media broadcast transmitted by the server (58) via the network (56). The streaming media broadcast includes a series of media programs, which may be played using the Internet media player (50). Further, the Internet media player (50) includes a display (54), which may be used to view information related to the streaming media broadcast, and a memo button (52), which may be used to mark a media program of interest. When pressed, the memo button (52) records a token, i.e., a digital marker, which includes at least a broadcast station identifier, i.e., a broadcasting frequency, and a timestamp representing a media program currently playing on the Internet media player (50). Each token recorded by a particular user is stored on the server (58) in a user profile (30) associated with the user. The user profile (30) is used to keep track of the tokens recorded by a single user. Further, the tokens included in a particular user profile (30) may be used to search the collection of media files (34) in order to locate a set of media files including media programs marked by the user and/or including information related to the marked media programs. The search may be performed by a media search engine (32), which is also located on the server (58).

FIG. 1b shows a process used to mark and view data representing a streaming media broadcast in accordance with the embodiment shown in FIG. 1a. In the first step (step 10), the server (58) transmits a streaming media broadcast via the network (56). In some embodiments, the server (58) generates the streaming media broadcast using files from a collection of media files (34) stored on the server (58). In another set of embodiments, the server (58) receives a media broadcast from a broadcasting station and converts the broadcast into a streaming media broadcast that may be played by the Internet media player (50).

Next, the Internet media player (50) receives and plays the streaming media broadcast (step 12). When a user hears/views a media program of interest (step 14), the user presses the memo button (52) to record a token that includes a broadcast station identifier and a timestamp obtained from either the Internet media player (50) or the streaming media program (step 16). In addition, the token (16) may also include a media clip taken from a data stream of the marked media program. For example, the media clip may include a clip of audio/video data starting a few seconds before the memo button is pressed and ending a few seconds after the memo button is pressed.

Once the media program has been marked, the token is transmitted to the server (58) via the network (56). The server (58) adds the token to the user profile (30) (step 18), or, if there is not a user profile, creates a new user profile including the token. Next, the server (58) uses the media search engine (32) in order to search the collection of media files (34) for a set of media files identified by the token (step 20). The set of media files may include a set of streaming media files transmitted as part of the streaming media broadcast and/or media files that include any information related to the streaming media files.

In some embodiments, the media search engine (32) locates the set of media files by using the token's broadcast station identifier to search for a corresponding station playlist, i.e., a media file including the names and start/end times of media programs played on the broadcast station over a particular interval of time, e.g., for the last three days. By comparing the same token's timestamp to the start and end times of the media programs listed in the station playlist, the media search engine (32) is able to determine which media program was playing at the time that the token was recorded. Thus, the media search engine (32) is able to identify the name of the media program identified by a particular token. Using the program name, the media search engine (32) may then be able identify other media files that include the program name, either as part of the name of the media file and/or as part of the text of the media file.

After locating the set of media files, the server adds the search results to the user profile (30) (step 22). Thus, the name of the media program is added to the token. In addition, streaming media files and/or other related media files are linked to the token so that the user may access the files. In order to view the token, the user logs into the user profile (30) via a network browser, e.g., an Internet browser, which may be viewed using the Internet media player's display (54) (step 24).

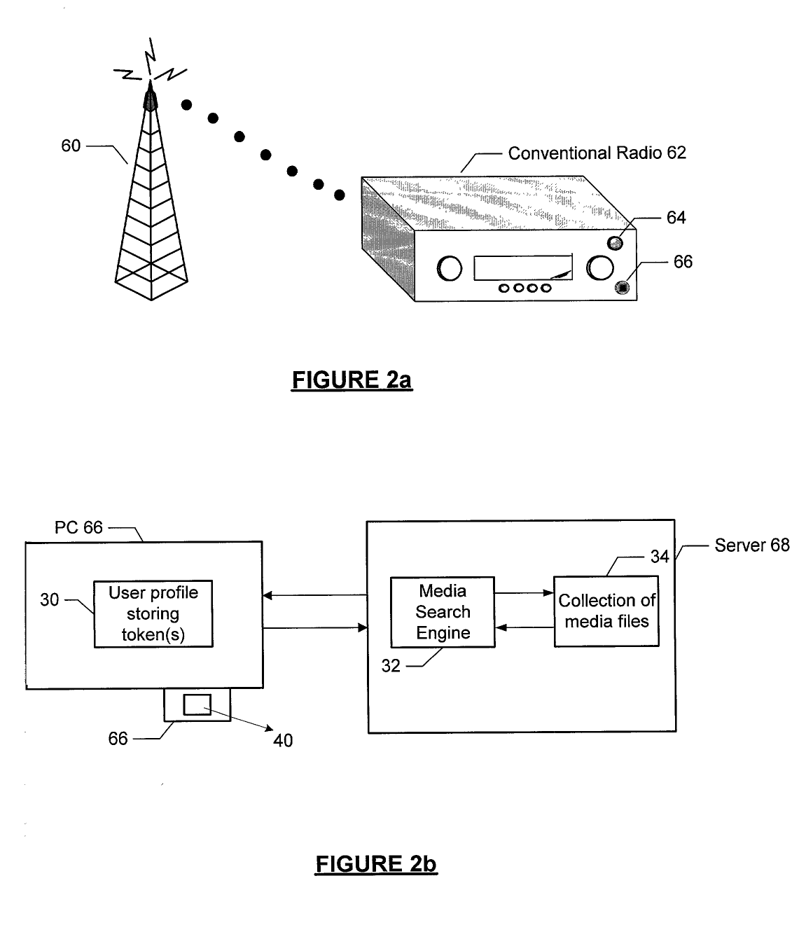

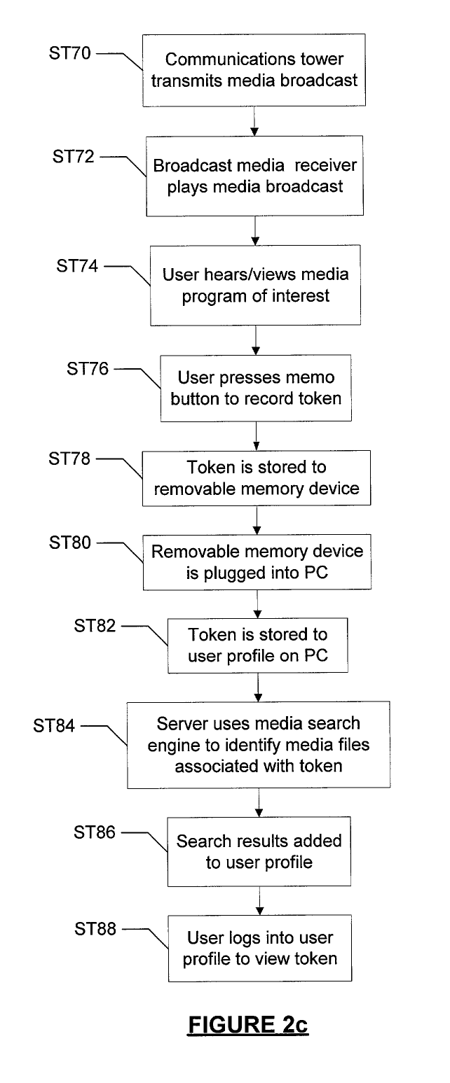

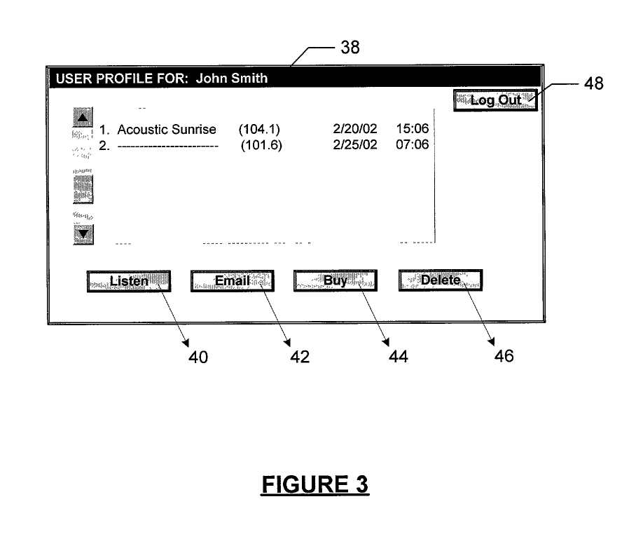

FIGS. 2a and 2b show a device used to mark and view data representing a conventional media broadcast. FIG. 2a shows a device used to mark data representing a conventional media broadcast. In FIG. 2a, a conventional radio (62) receives a conventional media broadcast transmitted by a communications tower (60). The conventional media broadcast includes a series of media programs, which may be played using the conventional radio (62). Further, the conventional radio (62) includes a memo button (64), which may be used to mark a media program of interest When pressed, the memo button (64) obtains a broadcast station identifier, i.e., a broadcasting frequency, and a timestamp from the conventional radio (62). The obtained data is used to create a token, which is stored on a removable memory device (66) attached to an input port, e.g., a USB port, of the conventional radio (62). In some embodiments, the removable memory device may be a prior art portable storage device, such as the DiskOnKey device developed by M-Systems, designed to plug into a USB port of a personal computer.

FIG. 2b shows a device used to view data representing a conventional media broadcast. As shown in FIG. 2b, after at least one token is stored on the removable memory device (66), the removable memory device (66) is plugged into an input port of a personal computer (PC) (66). The PC (66) stores the token to the user profile (30) associated with the user. Further, the tokens included in a particular user profile (30) may be transmitted to a server (68), so that the media search engine (32) may use the tokens to search the collection of media files (34). The media search engine (32) uses the tokens to locate a set of media files including media programs marked by the user and/or including information related to the marked media programs.

In the embodiment shown in FIG. 2b, the user profile (30) is stored on the PC (66). In alternative embodiments, the user profile (30) may be stored on the server (68). In order to view the user profile (30), the user logs into the user profile (30) via a network browser. In some embodiments, the removable storage device (66) includes a network address, i.e., a URL, that immediately opens a network browser showing a logon page for the user profile (30).

FIG. 2c shows a process used to mark and view data representing a conventional media broadcast in accordance with the embodiment shown in FIGS. 2a and 2b. In the first step (step 70), the communications tower (60) transmits a conventional media broadcast via air waves. Next, the conventional radio (62) receives and plays the conventional media broadcast (step 72). When a user hears/views a media program of interest (step 74), the user presses the memo button (64) to record a token that includes a broadcast station identifier and a timestamp obtained from the conventional radio (62) (step 76).

Once the media program has been marked, the token is stored to the removable memory device (66) (step 78), and the removable memory device is plugged into the PC (66) (step 80). The PC (66) stores the token to the user profile (30) (step 82), or, if there is not a user profile, creates a new user profile including the token. Next, the PC (66) transmits the token to the server (68), so the media search engine (32) can use the token in order to search the collection of media files (34) for a set of media files identified by the token (step 84). The set of media files may include media files containing the name of the marked media program.

In some embodiments, the media search engine (32) locates the set of media files by using the token's broadcast station identifier to search for a corresponding station playlist, i.e., a media file including the names and start/end times of media programs played on the broadcast station over a particular interval of time, e.g., for the last three days. By comparing the same token's timestamp to the start and end times of the media programs listed in the station playlist, the media search engine (32) is able to determine which media program was playing at the time that the token was recorded. Thus, the media search engine (32) is able to identify the name of the media program identified by a particular token. Using the program name, the media search engine (32) may then be able identify other media files that include the program name, either as part of the name of the media file and/or as part of the text of the media file.

After locating the set of media files, the server adds the search results to the user profile (30) (step 86). Thus, the name of the media program is added to the token. In addition, related media files are linked to the token so that the user may access the files. In order to view the token, the user logs into the user profile (30) via a network browser, e.g., an Internet browser, located on the PC (66) (step 88).

Those skilled in the art will appreciate that, in alternative embodiments, the last step (step 88) and the next to last step (step 86) may be reversed. Thus, the server may add the search results to the user profile (30) (step 86) after the user logs into the user profile (30) (step 88). Thus, until the user actually views the user profile (30), the PC memory that would have been used to store the search results may remain available.

In both the embodiments shown in FIG. 1 and FIG. 2, the user profile is viewed using a user profile menu, i.e., a screen display that allows a user to perform a set of options on the tokens stored in a particular user profile and/or view the data included in the tokens. FIG. 3 shows a user profile menu (38) for a user “John Smith”. In the embodiment shown in FIG. 3, user “John Smith” has created two tokens, herein referred to as token 1 and token 2, that are currently saved in user profile “John Smith”. Token 1 identifies a media program entitled “Acoustic Sunrise,” which John heard playing on broadcast station 104.1 on Feb. 20, 2002 at 3:06 p.m., and token 2 identifies a media program whose title is not given, which John heard playing on broadcast station 101.6 on Feb. 25, 2002 at 7:06 a.m.

By selecting either token 1 or token 2, the user may be able to perform any one of a number of menu options using a set of menu buttons. For example, the user may listen to, email, or buy a marked media program and/or delete the selected token using a Listen button (40), an Email button (42), a Buy button (44), or a Delete button (46), respectively. Because a separate broadcast station identifier was recorded in each token at the times that token 1 and token 2 were created, user “John Smith” is not required to alter a default broadcast station for the user profile menu (38) in order to determine the name of each marked media program. Thus, when the user selects a token to view, the user is not required to “guess” at the respective broadcast station in order to obtain the desired media program.

Note that, in token 2, the name of the media program is not given. This means that either the name was not found in any of the media files identified by the token or that the token does not identify any media files included in the collection of media files (34). Thus, the user may not be able to perform selected options, e.g., listen to, email, and buy, using token 2. However, the user may be able to use the data included in the token to manually locate the media program, e.g., by contacting the broadcast station.

In an alternative embodiment, a newly created token and/or related media program may be sent directly to a user via email. Thus, a user would not be required to log onto a user profile in order to view the token and/or view/hear the related media program.

Advantages of the present invention may include one or more of the following. In some embodiments, because a memo button used to mark a media program is located on an Internet media player, a user may mark a portion of a streaming media broadcast for later use.

In some embodiments, because a default broadcast station for a token is recorded in the token at the time that a media program is marked, a user may not be required to change a default broadcast station for a user profile each time the user views a new token in the user profile.

In some embodiments, because a token marking a media program may be directly forwarded to a user by email, a user may not be required to log onto a user profile to view information about the media program.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1] A method for recording data representing a portion of a media broadcast, comprising:
receiving a media broadcast using a broadcast media receiver having a selection device;
playing the media broadcast using the broadcast media receiver; and
recording a token during the portion of the media broadcast using the selection device, wherein the token comprises data representing the portion of the media broadcast.

2] The method of claim 1, wherein the media broadcast is a conventional media broadcast.

3] The method of claim 1, wherein the media broadcast is a streaming media broadcast.

4] The method of claim 1, wherein the token includes a broadcast station identifier identifying a broadcast station used to transmit the media broadcast.

5] A broadcast media receiver for marking a portion of a media broadcast, comprising:
a receiving device that plays the portion of the media broadcast;
a selection device, wherein activating the selection device during the portion of the media broadcast creates a token; and
a recording device for storing the token, wherein recording the token to the recording device marks the portion of the media broadcast.

6] The broadcast media receiver of claim 5, wherein the token includes data representing the portion of the media broadcast.

7] The broadcast media receiver of claim 5, wherein the broadcast media receiver is used to play a conventional media broadcast.

8] The broadcast media receiver of claim 5, wherein the broadcast media receiver is used to play a streaming media broadcast.

9] The broadcast media receiver of claim 5, wherein the selection device is used to capture data representing the portion of the media broadcast.

10] A method for retrieving data representing a portion of a media broadcast, comprising:
playing the media broadcast using a broadcast media receiver having a selection device;
recording a token during the portion of the media broadcast using the selection device, wherein the token represents the portion of the media broadcast;
storing the token in a user profile; and
retrieving data representing the portion of the media broadcast using the user profile.

11] The method of claim 10, wherein the data representing the portion of the media broadcast is retrieved from a collection of media files.

12] The method of claim 11, wherein the data representing the portion of the media broadcast is retrieved using a media search engine.

13] A device for retrieving data representing a portion of a media broadcast, comprising:
broadcast media receiver means for playing the portion of the media broadcast;
selection device means located on the broadcast media receiver means for creating a token representing the portion of the media broadcast; and
recording device means activated by the selection device means for storing the token, wherein the recording device means uses the token to retrieve data representing the portion of the media broadcast.
